(19) United States
(12) Patent Application Publication
(10) Pub. No.: US 2024/0248309 A1
(43) Pub. Date: Jul. 25, 2024

(54) VIRTUAL IMAGE DISPLAY DEVICE AND HEAD-MOUNTED DISPLAY APPARATUS

(71) Applicant: SEIKO EPSON CORPORATION, Tokyo (JP)

(72) Inventor: Takashi TAKEDA, Suwa-shi (JP)

(73) Assignee: SEIKO EPSON CORPORATION, Tokyo (JP)

(21) Appl. No.: 18/416,233

(22) Filed: Jan. 18, 2024

(30) Foreign Application Priority Data
Jan. 19, 2023 (JP) 2023-006397

(51) Int. Cl. G02B 27/01

(52) U.S. Cl. CPC G02B 27/0172; G02B 2027/0178

(57) ABSTRACT

A virtual image display device includes: a light modulation element including a liquid crystal pixel and a light-transmitting region, a light-blocking member arranged at the external side of the light modulation element, a light-guiding member arranged between the light-blocking member and the light modulation element , a first polarizing plate arranged between the light-guiding member and the light-transmitting region to polarized light in a first polarization direction, a second polarizing plate arranged at the face side of the light modulation element and including a polarizing film as a polarizing region provided corresponding to the liquid crystal pixel, the polarizing film being configured to restrict image light emitted from the liquid crystal pixel to polarized light in a second polarization direction, and a polarization separation lens element arranged at the face side of the second polarizing plate that functions with respect to polarized light of the image light.

The present application is based on, and claims priority from JP Application Serial Number 2023-006397, filed Jan. 19, 2023, the disclosure of which is hereby incorporated by reference herein in its entirety.

### BACKGROUND

### 1. Technical Field

The present disclosure relates to a virtual image display device and a head-mounted display apparatus that enable observation of a virtual image, and more particularly to a virtual image display device and the like of a see-through type that enable visual recognition of an external image.

### 2. Related Art

As a see-through type virtual image display device that enables visual recognition of an outside world, a virtual image display device is known that includes a liquid crystal panel including an image display region and a transparent display region formed surrounding this image display region, and a light-guiding plate that guides backlight incident from a light source on an end portion, and in which the light-guiding plate includes a light-emitting region that irradiates the image display region of the liquid crystal panel with the backlight, and a light-transmitting region that transmits ambient light (WO 2016/056298). The display device is configured such that ambient light reaches an observer from the light-transmitting region of the light-guiding plate and the transparent display region of the liquid crystal panel, and the ambient light is transmitted through the light-emitting region of the light-guiding plate and the image display region of the liquid crystal panel and reaches the observer during a period in which the image display region is not irradiated with the backlight. With such a configuration, see-through display in which image light and ambient light are superimposed on each other is achieved.

In the above-described device, processing such as formation of dots and application of a scattering material is performed on the light-emitting region of the light-guiding plate, and the ambient light passing through the image display region of the liquid crystal panel passes through the processed light-emitting region, so that see-through transmittance decreases in a vicinity of a center of a visual field corresponding to the image display region. In order to achieve see-through display with high see-through transmittance in the vicinity of the center of the visual field, an optical system or the like with high see-through transmittance is separately required, which leads to an increase in size.

### SUMMARY

A virtual image display device in an aspect of the present disclosure includes: a light modulation element including a liquid crystal pixel and a light-transmitting region configured to transmit light, a light-blocking member arranged at an external side of the light modulation element and configured to suppress incidence of external light on the liquid crystal pixel, a light-guiding member arranged between the light-blocking member and the light modulation element and configured to emit, at a position corresponding to that of the liquid crystal pixel, illumination light toward the liquid crystal pixel, a first polarizing plate arranged between the light-guiding member and the light modulation element and configured to restrict light incident on the liquid crystal pixel and the light-transmitting region to polarized light in a first polarization direction, a second polarizing plate arranged at a face side of the light modulation element and including a polarizing region provided corresponding to the liquid crystal pixel, the polarizing region being configured to restrict image light emitted from the liquid crystal pixel to polarized light in a second polarization direction different from the first polarization direction, and a polarization separation lens element arranged at a face side of the second polarizing plate and having refractive power configured to selectively act on polarized light of the image light.

### BRIEF DESCRIPTION OF THE DRAWINGS

FIG. 1 is an external perspective view for describing a mounted state of a virtual image display device of a first embodiment.

FIG. 2 is a conceptual perspective view for describing an optical structure of a display optical system.

FIG. 3 is an enlarged perspective view for describing a repetition unit of a composite display member.

FIG. 4 is a conceptual enlarged perspective view for describing a light extraction unit of a light-guiding member.

FIG. 5 is a conceptual perspective view for describing an example of a specific structure of a light modulation element.

FIG. 6 illustrates a state in which a polarizing plate, the light modulation element, the light-guiding member and a light-blocking member are seen through.

FIG. 7 is a conceptual perspective view for describing a structure and a function of a polarization separation lens element.

FIG. 8 is a conceptual diagram for describing operation of the virtual image display device of the first embodiment.

FIG. 9 is an external diagram for describing a virtual image display device of a second embodiment.

### DESCRIPTION OF EMBODIMENTS

### First Embodiment

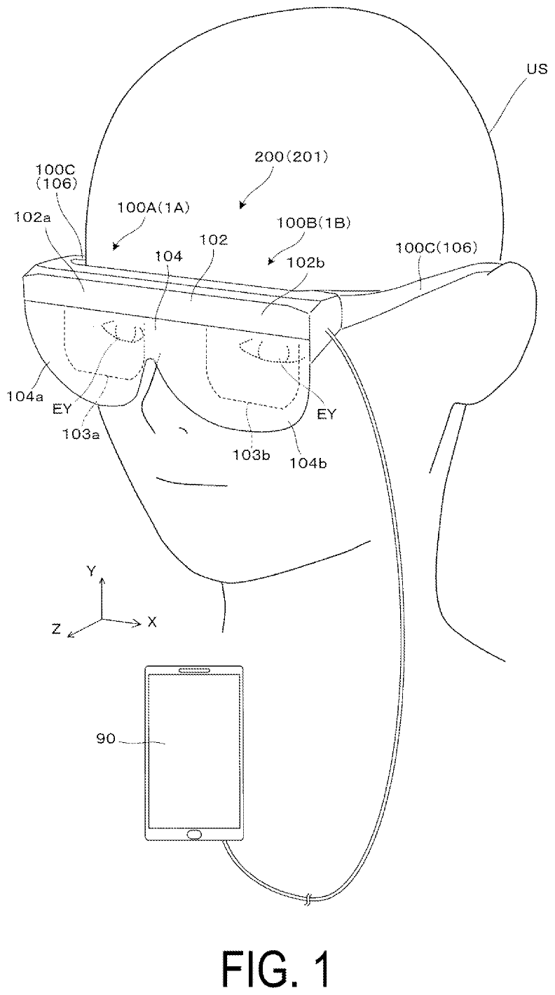

With reference to FIGS. 1 to 8, a virtual image display device of a first embodiment of the present disclosure will be described below.

FIG. 1 is a perspective view for describing a mounted state of a head-mounted display, that is, a head-mounted display apparatus 200. The head-mounted display apparatus (hereinafter also referred to as an HMD) 200 is a display apparatus 201 of a binocular type, and allows an observer or a wearer US who wears the HMD 200 to recognize a video as a virtual image. In FIG. 1 and the like, X, Y, and Z indicate an orthogonal coordinate system, a +X direction corresponds to a lateral direction in which both eyes EY of the observer or wearer US wearing the HMD 200 are aligned, a +Y direction corresponds to an upward direction orthogonal to the lateral direction in which both the eyes EY are aligned for the wearer US, and a +Z direction corresponds to a forward or front direction for the wearer US. The ±Y directions are parallel to a vertical axis or a vertical direction.

The HMD 200 includes a first virtual image display device 100A for a right eye, a second virtual image display device 100B for a left eye, a pair of temples 100C that support the virtual image display devices 100A and 100B, and a user terminal 90 being an information terminal. The first virtual image display device 100A is a first device 1A, and is constituted by a first display driving unit 102a that is arranged at an upper part, a first display optical system 103a that covers a front of the eye, and a light-transmitting cover 104a that covers the first display optical system 103a from the external side or a front side thereof. The second virtual image display device 100B is a second device 1B, and is constituted by a second display driving unit 102b that is arranged at an upper part, a second display optical system 103b that covers the front of the eye, and a light-transmitting cover 104b that covers the second display optical system 103b from the external side or the front side thereof. The HMD 200 obtained by combining the first virtual image display device 100A being the first device 1A and the second virtual image display device 100B being the second device 1B with each other is also a virtual image display device in a broader sense. The pair of temples 100C function as a mounting member or a support device 106 that is worn on the head of the wearer US, and support the upper end sides of the pair of display optical systems 103a and 103b and the upper end sides of the pair of light-transmitting covers 104a and 104b via the display driving units 102a and 102b integrated in exterior. A combination of the pair of display driving units 102a and 102b is referred to as a driving device 102. A combination of the pair of light-transmitting covers 104a and 104b is referred to as a shade 104.

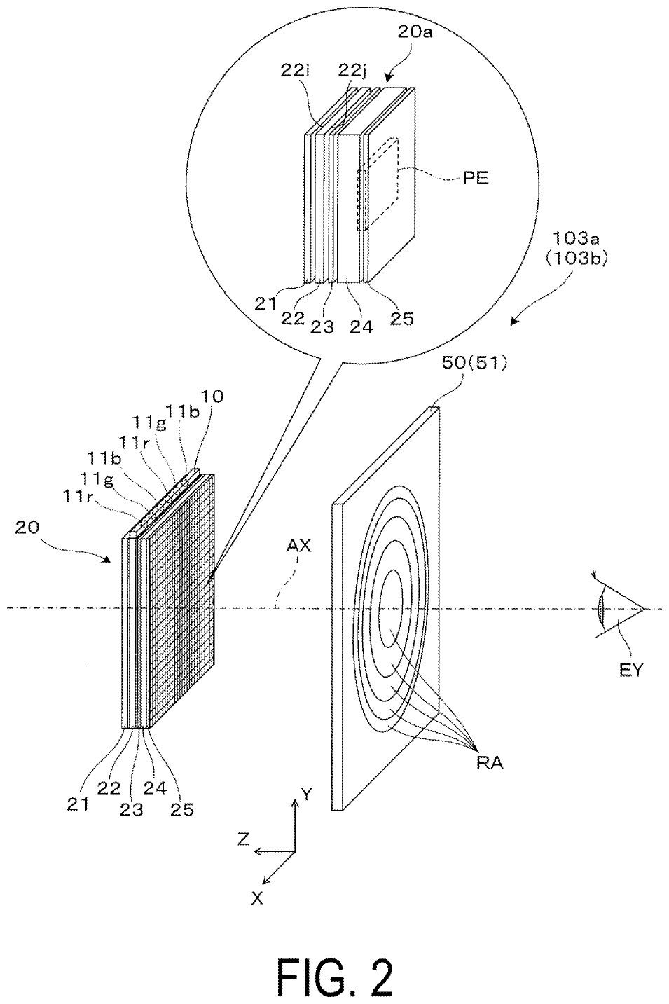

FIG. 2 is a perspective view for describing a structure of the first display optical system 103a. The first display optical system 103a includes a light source device 10 that generates light of three colors as illumination light in a time-division manner, a plate-shaped composite display member 20 that forms a two-dimensional image and emits image light, and a polarization separation lens element 50 that functions as a lens for the image light. The light source device 10 is a part of the first display driving unit 102a illustrated in FIG. 1, and is arranged above and near an upper side of a light-guiding member 22 of the composite display member 20 described later to supply illumination light from an upper end side to the light-guiding member 22. The composite display member 20 and the polarization separation lens element 50 are arranged spaced apart from each other in an optical axis AX direction. In the first display optical system 103a, a distance between the eye EY and the polarization separation lens element 50 is, for example, about 10 mm to 20 mm. Further, a distance between the composite display member 20 and the polarization separation lens element 50 is, for example, about 3 mm to 25 mm.

The composite display member 20 is a plate-like member that extends along an XY plane vertical to the optical axis AX, is a plate-like member as a whole in which a light-blocking member 21, the light-guiding member 22, a first polarizing plate 23, a light modulation element 24 and a second polarizing plate 25 are layered, and has a structure integrated by a frame body (not illustrated). Here, the light-blocking member 21, the light-guiding member 22, the first polarizing plate 23, the light modulation element 24, and the second polarizing plate 25 are bonded and fixed in a state of being arranged nearby with predetermined intervals therebetween. This makes it possible to make the device relatively thin. Note that the first polarizing plate 23, the light modulation element 24 and the second polarizing plate 25 maybe in close contact with each other. The composite display member 20 is configured by a plurality of repetition units 20a that are arrayed in a matrix along the XY plane. The repetition unit 20a includes liquid crystal pixels PE each of which is a unit for forming an image in the light modulation element 24. In the composite display member 20, the light-guiding member 22 is a parallel flat plate-shaped member including a pair of flat surfaces 22i and 22j, and is arranged between and in the vicinity of the light-blocking member 21 and the first polarizing plate 23. However, the light-guiding member 22 is arranged away from the light-blocking member 21 and the first polarizing plate 23 from a viewpoint of exhibiting a function thereof. To be more specific, the pair of flat surfaces 22i and 22j of the light-guiding member 22 are arranged at distances of several μm or more and 50 μm or less from respective facing surfaces of the light-blocking member 21 and the first polarizing plate 23. Accordingly, it is possible to reduce the device in thickness and weight while securing propagation of illumination light in the light-guiding member 22.

The polarization separation lens element 50 functions as a lens for the image light ML. The polarization separation lens element 50 is arranged at a face side, that is, a −Z side of the second polarizing plate 25 of the composite display member 20 to cover the front of the eye. The polarization separation lens element 50 is an independent lens that collectively causes a plurality of the liquid crystal pixels PE constituting the light modulation element 24 to form an image. That is, the polarization separation lens element 50 collectively causes light corresponding to each liquid crystal pixel PE to form an image. By forming the polarization separation lens element 50 as an independent lens, an eye box can be easily enlarged. The polarization separation lens element 50 is a plate-like member that extends along the XY plane. The polarization separation lens element 50 is specifically a liquid crystal lens 51, and includes a plurality of orbicular zones RA each having a circular shape and a different refractive index state. The orbicular zones RA in a group are concentrically arranged symmetrically about the optical axis AX. In the group of the orbicular zones RA, the orbicular zone RA in a periphery away from the optical axis AX has a width in a radial direction with the optical axis Ax as a center, which is smaller than that of the orbicular zone RA at a center through which the optical axis AX passes. In other words, the width of the orbicular zone RA in the radial direction is smaller as approaching the periphery.

The polarization separation lens element 50 acts on polarized light in a perpendicular direction or the vertical direction and does not act on polarized light in a horizontal direction. The polarization separation lens element 50 acting on the polarized light in the perpendicular direction has a focal point at a position of the light modulation element 24, or has refractive power comparable to a case in which the focal point is at the position of the light modulation element 24. Thus, the image light ML is emitted substantially parallel to the eye EY. As a result, an image and an external image are superimposed on the retina of the eye EY, and AR display can be performed.

The second display optical system 103b is optically the same as the first display optical system 103a, or is obtained by inverting the first display optical system 103a horizontally. Thus, detail description thereof is omitted.

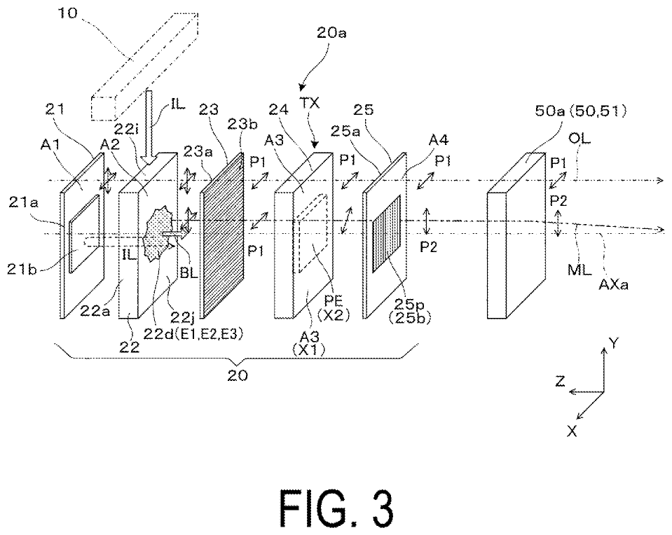

As illustrated in FIG. 3, the light-blocking member 21 is obtained by providing a rectangular light-blocking layer 21b at a flat plate 21a that transmits light. Although omitted in illustration, on the entire light-blocking member 21, the large number of light-blocking layers 21b are arrayed in a matrix along the XY plane. In other words, all the light-blocking layers 21b constituting the light-blocking member 21 are two-dimensionally arrayed periodically with respect to a horizontal X direction and a vertical Y direction. Each of the light-blocking layers 21b is formed in a region corresponding to a pixel in each of the repetition units 20a (specifically, a region in which the liquid crystal pixel PE is formed at the light modulation element 24). A light-transmitting region A1 of the light-blocking member 21 in which the light-blocking layer 21b is not provided transmits external light OL, but the light-blocking layer 21b blocks the external light OL.

The light-blocking layer 21b is formed by light-absorbing or light-reflecting paint or other substances that can be applied to a desired area by an ink-jet method, for example. A mold release pattern formed with a mold release agent is recorded in advance at a position at the flat plate 21a at which the light-blocking layer 21b is not formed. A spray containing light-absorbing substances is applied over the entire surface, and then the light-absorbing substances are removed at the position corresponding to the mold release pattern. With this, the light-blocking layer 21b may be made of the remaining light-absorbing substance layer. Paint having a color other than black may be used for the light-blocking layer 21b as long as the paint has a light-absorbing action or a light-reflecting action. Moreover, as the light-blocking layer 21b, a mirror may be used in which a pattern of a reflective material such as metal is formed by using a photo-resist technique or the like at a position at the flat plate 21a at which the light-blocking layer 21b is to be formed. The light-blocking layers 21b may be formed by oxidizing a metal pattern formed using a photo-resist technique or the like to improve an absorbing property. When the light-blocking layer 21b is a mirror, it is possible to reflect illumination light IL traveling from a light extraction unit 22d of the light-guiding member 22 to be described later toward the external side, and to use the illumination light IL as backlight BL traveling toward the light modulation element 24. Note that the light-blocking layer 21b is not limited to one formed at the face side of the flat plate 21a and may be formed at the external side of the flat plate 21a.

The light-guiding member 22 is obtained by providing the light extraction unit 22d, for example, at a flat plate 22a that transmits light. The light extraction unit 22d can efficiently extract the illumination light IL at a necessary position, by disturbing propagation of the illumination light IL using total reflection or the like by the parallel flat plate-shaped light-guiding member 22. Although omitted in illustration, at the entire light-guiding member 22, a large number of the light extraction units 22d are arrayed in a matrix along the XY plane. In other words, all the light extraction units 22d constituting the light-guiding member 22 are two-dimensionally arrayed periodically with respect to the horizontal X direction and the vertical Y direction.

The light extraction unit 22d is a light scattering layer E1 formed at, for example, the flat surface 22j on the light modulation element 24 side of the pair of flat surfaces 22i and 22j constituting the light-guiding member 22, but the light scattering layer E1 can be replaced with a nanostructure E2 or a microlens E3. A total reflection condition of the illumination light IL propagating through the light-guiding member 22 while being reflected by the flat surfaces 22i and 22j is broken by the light extraction unit 22d, and the backlight BL leaks from the light extraction unit 22d toward the first polarizing plate 23. Accordingly, the light-guiding member 22 can emit the illumination light IL toward the liquid crystal pixel PE of the light modulation element 24 described later. To be specific, when the light extraction unit 22d is the light scattering layer E1, the illumination light IL propagating through the light-guiding member 22 is scattered by the light scattering layer E1, a propagation direction of the illumination light IL is randomly dispersed outward the flat surface 22j, and the illumination light IL is emitted in a −Z direction as a whole. When the light extraction unit 22d is the nanostructure E2, the illumination light IL propagating through the light-guiding member 22 is deflected by refraction or interference at the nanostructure E2, and the illumination light IL is emitted in the-Z direction as a whole. In this case, it is easy to control an emission direction of the backlight BL. When the light extraction unit 22d is the microlens E3, the illumination light IL propagating through the light-guiding member 22 is refracted by the microlens E3, and the illumination light IL can be emitted in the-Z direction as a whole by adjusting a surface shape or an inclination of the microlens E3. That is, the illumination light IL propagating through the light-guiding member 22 is extracted outside from the light-guiding member 22 by the light extraction unit 22d. In the light-guiding member 22, by appropriately setting a position where the light extraction unit 22d is provided, the illumination light IL can be efficiently extracted at a necessary position of the light-guiding member 22. When the light extraction unit 22d is the light scattering layer, a mask is formed at a front surface of the flat surface 22j, an opening thereof is subjected to a physical or chemical treatment to form a fine scattering structure, and the mask is finally removed. When the light extraction unit 22d is the nanostructure, a scattering structure is formed at an appropriate position of the front surface of the flat surface 22j by using a nano-imprint method or the like. When the light extraction unit 22d is the microlens, a transfer surface having a lens shape is processed in advance in a molding die of the light-guiding member 22.

On the other hand, the light-guiding member 22 transmits light incident on the flat surface 22i from outside to the flat surface 22j side. That is, the light-guiding member 22 includes a light-transmitting region A2 that at least partially transmits the external light OL that arrives without being blocked by the light-blocking member 21. A flat plate portion of the light-guiding member 22 other than a portion where the light extraction unit 22d is provided is used as the light-transmitting region A2.

The light source device 10 attached to the light-guiding member 22 generates light of three colors in a time-division manner as the illumination light IL for backlight and supplies the light of three colors to the light-guiding member 22. The three colors of the illumination light IL can express, for example, any color within a color gamut required for a display image, and are selected to produce white light when superimposed on each other. In a concrete example, as conceptually illustrated in FIG. 2, the light source device 10 includes an R light-emitting element 11r that emits red light, a G light-emitting element 11g that emits green light and a B light-emitting element 11b that emits blue light. The R light-emitting element 11r, the G light-emitting element 11g and the B light-emitting element 11b may be self-emitting devices, for example, light-emitting diodes such as an organic light-emitting diode (OLED) and a micro light-emitting diode (μLED) made of an inorganic material. The R light-emitting element 11r, the G light-emitting element 11g, and the B light-emitting element 11b are not limited to being incorporated alone. In other words, the light source device 10 is a combination of one or more R light-emitting elements 11r, one or more G light-emitting elements 11g and one or more B light-emitting elements 11b. A combiner/splitter including a beam splitter can be incorporated between the light source device 10 and the light-guiding member 22 to assist diffusion of the illumination light IL.

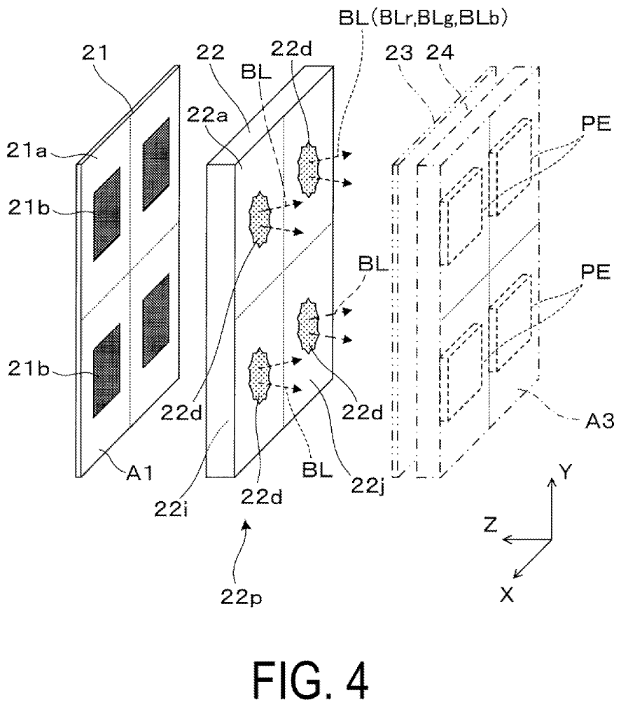

As illustrated in FIG. 4, the backlight BL emitted from the light-guiding member 22 is emitted as a whole in a direction orthogonal to the flat surface 22j, that is, in an angular direction centered on the-Z direction parallel to the optical axis AX. Each light extraction unit 22d is discretely formed in a region corresponding to the liquid crystal pixel PE of the light modulation element 24 in each repetition unit 20a, and radiates the backlight BL toward the corresponding liquid crystal pixel PE via the first polarizing plate 23. The backlight BL includes red light BLr corresponding to an illumination light component from the R light-emitting element 22r illustrated in FIG. 2, green light BLg corresponding to an illumination light component from the G light-emitting element 11g, and blue light BLb corresponding to an illumination light component from the B light-emitting element 11b, and is output while the red light BLr, the green light BLg and the blue light BLb are switched. That is, the light extraction unit 22d emits the red light BLr, the green light BLg and the blue light BLb, which are the light of three colors, to the liquid crystal pixel PE. A size of the light extraction unit 22d of the light-guiding member 22 is equal to a size of the liquid crystal pixel PE of the light modulation element 24, or slightly smaller than the size of the liquid crystal pixel PE. When the size of the light extraction unit 22d is smaller than the size of the liquid crystal pixel PE, it is possible to cause the backlight BL to be entirely incident on the liquid crystal pixel PE, even when the backlight BL emitted from the light extraction unit 22d is diffused. Note that the light extraction units 22d are not limited to being entirely provided discretely. Some of the light extraction units 22d may be coupled to each other as long as imaging of the image light ML is not greatly affected.

The light source device 10 and the light-guiding member 22 illustrated in FIG. 3 and the like operate as follows, for example, to generate light of three primary colors, that is, light of red, green, and blue in a time-division manner. In a period in which the red light is generated as the backlight BL (hereinafter also referred to as a “red light emission period”), the R light-emitting element 11r illustrated in FIG. 2 is turned on, and each liquid crystal pixel PE of the light modulation element 24 is illuminated with the red light BLr. In a period in which the green light is generated as the backlight BL (hereinafter also referred to as a “green light emission period”), the G light-emitting element 11g is turned on, and each liquid crystal pixel PE of the light modulation element 24 is illuminated with the green light BLg. In a period in which the blue light is generated as the backlight BL (hereinafter also referred to as a “blue light emission period”), the B light-emitting element 11b is turned on, and each liquid crystal pixel PE of the light modulation element 24 is illuminated with the green light BLb.

In addition to the red light emission period, the green light emission period and the blue light emission period, a total light emission period in which all of the R light-emitting element 11r, the G light-emitting element 11g and the B light-emitting element 11b emit light may be provided. By providing the total light emission period, luminance of a display image can be increased as a whole.

Referring back to FIG. 3, the first polarizing plate 23 of the composite display member 20 is arranged at the face side of the light-guiding member 22, and is configured to restrict transmitted light to horizontally polarized light that is polarized light in a predetermined polarization direction, specifically, a first polarization direction, and to block vertically polarized light which is polarized light in a second polarization direction orthogonal to the first polarization direction. In the illustrated embodiment, horizontally polarized light having a polarization plane parallel to left and right ±X directions is first polarized light P1, and vertically polarized light having a polarization plane parallel to the upper and lower ±Y directions is second polarized light P2. Due to an action of the first polarizing plate 23, of the external light OL which passes through the light-transmitting region A1 of the light-blocking member 21, and the like, and the backlight BL which is emitted from the light-guiding member 22, the second polarized light P2 which is the vertically polarized light is blocked by the first polarizing plate 23 and the first polarized light P1 which is the horizontally polarized light passes through the first polarizing plate 23. The horizontally polarized light that passes through the first polarizing plate 23, that is, the first polarized light P1 is incident on the liquid crystal pixel PE of the light modulation element 24 described later and a light-transmitting region A3. The first polarizing plate 23 is obtained by, for example, bonding a polarizing film 23b of an absorbing type at a flat plate 23a that transmits light. The polarizing film 23b may be, for example, a resin sheet obtained by extending polyvinyl alcohol (PVA) with iodine adsorbed thereon in a specific direction. In the illustrated example, the polarizing film 23b only transmits the vertically polarized light having a polarization plane parallel to the left and right ±X direction, that is the first polarized light P1, and absorbs the horizontally polarized light having a polarization plane parallel to the upper and lower ±Y direction, that is the second polarized light P2. The first polarizing plate 23 or the polarizing film 23b absorbs the vertically polarized light that is not used for forming an image, that is, the second polarized light P2, so that it is possible to suppress generation of stray light.

In the composite display member 20, the light modulation element 24 is arranged at the face side of the first polarizing plate 23, and the second polarizing plate 25 is arranged at the face side of the light modulation element 24.

The light modulation element 24 and the second polarizing plate 25 are configured to modulate the backlight BL incident on the liquid crystal pixel PE in accordance with image data corresponding to a display image to generate the image light ML. Specifically, each liquid crystal pixel PE of the light modulation element 24 is driven by a drive voltage corresponding to a gradation of each liquid crystal pixel PE indicated by the image data, rotates a polarization plane of the backlight BL by an angle corresponding to the drive voltage, and emits the image light ML. A vertical polarization component of the image light ML emitted from the liquid crystal pixel PE has intensity corresponding to a signal component, that is, the gradation of the liquid crystal pixel PE. The light modulation element 24 transmits the external light OL without acting on a polarization plane of the external light OL in the light-transmitting region A3. The second polarizing plate 25 includes a rectangular polarizing region 25p at a flat plate 25a that transmits light. The polarizing region 25p is a polarizing film 25b which is discretely provided corresponding to the liquid crystal pixel PE, and restricts the image light ML emitted from the liquid crystal pixel PE to polarized light in the second polarization direction different from the first polarization direction. That is, the polarizing region 25p is configured to restrict transmitted light to the second polarized light P2 that is polarized light in a predetermined polarization direction or, to be specific, the second polarization direction, and to block the first polarized light P1 that is polarized light in the first polarization direction orthogonal to the second polarization direction. In the embodiment of FIG. 3, while a horizontal polarization component of the image light ML is removed, the external light OL and the vertical polarization component which is a signal component of the image light ML are transmitted through the second polarizing plate 25. Since the second polarizing plate 25 includes the patterned polarizing film 25b unlike the first polarizing plate 23, for example, a wire grid type polarizing plate is uniformly formed at one surface of the flat plate 25a, a portion where the polarizing film 25b is to be formed is protected by a mask, and a wire grid pattern around the portion is removed by etching. Finally, by removing the mask, the polarizing film 25b formed by a wire grid type polarizing region can be formed at the flat plate 25a in a desired size and pattern. In the example illustrated in FIG. 3, the polarizing film 25b only transmits vertically polarized light having a polarization plane parallel to the upper and lower ±Y direction, that is the second polarized light P2, and reflects or absorbs horizontally polarized light having a polarization plane parallel to the left and right ±X direction, that is the first polarized light P1.

The second polarizing plate 25 includes a light-transmitting region A4 that at least partially transmits the external light OL passing through the light-transmitting region A3 of the light modulation element 24. A flat plate portion of the second polarizing plate 25 other than the polarizing region 25p where the polarizing film 25b is provided is used as the light-transmitting region A4.

In order to achieve color display, each liquid crystal pixel PE of the light modulation element 24 is driven in synchronization with generation of the backlight BL of the three primary colors from the light-guiding member 22 in a time-division manner. In the red light emission period in which the red light BLr is generated as the backlight BL, the liquid crystal pixel PE is driven by a drive voltage corresponding to a gradation of red. Similarly, in the green light emission period in which the green light BLg is generated as the backlight BL, the liquid crystal pixel PE is driven by a drive voltage corresponding to a gradation of green, and in the blue light emission period in which the blue light BLb is generated as the backlight BL, the liquid crystal pixel PE is driven by a drive voltage corresponding to a gradation of blue. Since the light-guiding member 22 generates the light of three primary colors as the backlight BL in a time-division manner and irradiates the liquid crystal pixels PE with the light, it is permissible for a resolution of the light modulation element 24, that is, a density of the liquid crystal pixels PE to be low even when color display is performed. This makes it possible to increase a proportion of the light-transmitting region A3 in the light modulation element 24 and improve a see-through transmittance.

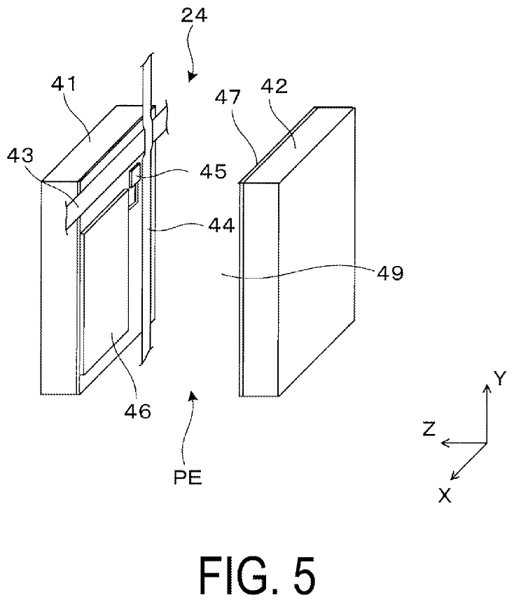

FIG. 5 is a conceptual perspective view for describing an example of a specific structure of the light modulation element 24. FIG. 5 particularly illustrates a structural portion corresponding to the liquid crystal pixel PE, in one repetition unit 20a constituting the light modulation element 24. In the illustrated example, the light modulation element 24 is configured as an active matrix-type liquid crystal panel. The light modulation element 24 includes a first substrate 41, and a second substrate 42 arranged to face the first substrate 41. The first substrate 41 and the second substrate 42 are each made of glass or plastic that transmits light, for example. A space between the first substrate 41 and the second substrate 42 is filled with a liquid crystal 49. As the liquid crystal 49, for example, a TN liquid crystal, an in-plane switching (IPS) liquid crystal, or a vertical alignment (VA) liquid crystal may be used. At the first substrate 41, a scanning line 43 which may be referred to as a gate line, a signal line 44 which may be referred to as a source line, a driving element 45 which is a switch element, and a pixel electrode 46 are formed. In the illustrated embodiment, the scanning line 43 is provided extending parallel to an X-axis, and the signal line 44 is provided extending parallel to a Y-axis. The driving element 45 includes a thin film transistor (TFT), and is configured as the switch element that electrically couples the scanning line 43 and the pixel electrode 46 when the scanning line 43 is selected by pulling up the scanning line 43 to a high potential, for example. A counter electrode 47 maintained at a common voltage is formed at the second substrate 42. The pixel electrode 46, the counter electrode 47 and the liquid crystal 49 present therebetween constitute the liquid crystal pixel PE of the repetition unit 20a. Although not illustrated in the drawing, an alignment film is disposed between the pixel electrode 46 and the counter electrode 47 to adjust an initial alignment state of the liquid crystal 49. Describing an example of operation, the liquid crystal pixel PE is configured, when a drive voltage corresponding to a gradation of the liquid crystal pixel PE indicated by image data is written, to rotate a polarization plane of backlight incident on the liquid crystal pixel PE by an angle corresponding to the drive voltage and emit the image light ML. Writing of a driving electrode into the liquid crystal pixel PE is performed by supplying a drive voltage from a driver (not illustrated) to the pixel electrode 46 via the signal line 44 and the driving element 45 in a state where the scanning line 43 is selected and the driving element 45 is on.

The illustrated light modulation element 24 has a structure in which the liquid crystal pixel PE is housed in a liquid crystal cell filled with the liquid crystal 49, and no liquid crystal is present outside the liquid crystal cell. In such a structure, the external light OL does not pass through a liquid crystal layer in the light-transmitting region A3 outside the liquid crystal pixel PE, thus the external light OL passing through the light-transmitting region A3 is maintained to be horizontally polarized light even when one that rotates a polarization plane even when no voltage is applied is used as the liquid crystal 49. Note that a liquid crystal that does not rotate a polarization plane when no voltage is applied does not affect a polarization state of the external light OL, even when an outside of the liquid crystal cell is filled with such a liquid crystal.

In the description related to FIG. 3, the first polarizing plate 23 transmits the external light OL and the image light ML each being the first polarized light P1 that is the horizontally polarized light, and the polarizing film 25b of the second polarizing plate 25 selectively transmits the image light ML being the second polarized light P2 which is the vertically polarized light, but the first polarizing plate 23 may transmit the image light ML being vertically polarized light. In this case, the polarizing film 25b of the second polarizing plate 25 selectively transmits the image light ML being horizontally polarized light. As for the light modulation element 24, one that corresponds to a polarization plane of the first polarizing plate 23 or the second polarizing plate 25 is used. With regard to the liquid crystal lens 51 as well, which is described later, along with changes of the polarization directions of the first polarizing plate 23 and the polarizing film 25b of the second polarizing plate 25, polarization directions for functioning as a lens are changed accordingly.

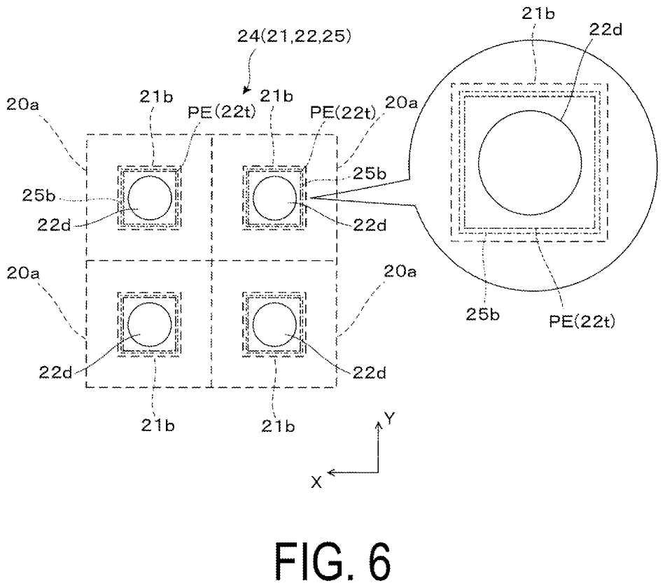

FIG. 6 is a diagram in which the light modulation element 24 is seen through from the second polarizing plate 25 side, and the light-blocking member 21 and the light-guiding member 22 in a state of being seen-through are superimposed and illustrated. In this case, the light-blocking layer 21b of the light-blocking member 21 covers the liquid crystal pixel PE corresponding to the pixel section 22t of the repetition unit 20a, and is formed in a region that spreads slightly outward from the pixel section 22t or the liquid crystal pixel PE, but may be formed in a region matching with the pixel section 22t or the liquid crystal pixel PE. The light extraction unit 22d of the light-guiding member 22 is formed in a region that is slightly narrower than the pixel section 22t or the liquid crystal pixel PE, but may be formed in a region substantially matching with the pixel section 22t or the liquid crystal pixel PE. The light-blocking layer 21b of the light-blocking member 21 has a size corresponding to the light extraction unit 22d or the liquid crystal pixel PE. To be more specific, the light-blocking layer 21b is formed in a region extending slightly outward from the light extraction unit 22d. The polarizing film 25b of the second polarizing plate 25 covers the pixel section 22t or the liquid crystal pixel PE, and is formed in a region that spreads slightly outward from the pixel section 22t or the liquid crystal pixel PE, but may be formed in a region matching with the pixel section 22t or the liquid crystal pixel PE. A size of the light modulation element 24 or the like is, for example, about 1 inch. In the first display optical system 103a, the number of pixels is about 2K to 4K. A size of the liquid crystal pixel PE is, for example, about 10 μm square to 40 μm square. A size of the light extraction unit 22d of the light-guiding member 22 is, for example, about 4 μm square to 30 μm square. In order to ensure see-through light, (light extraction area)/(pixel section area) is, for example, about 0.3 to 0.8.

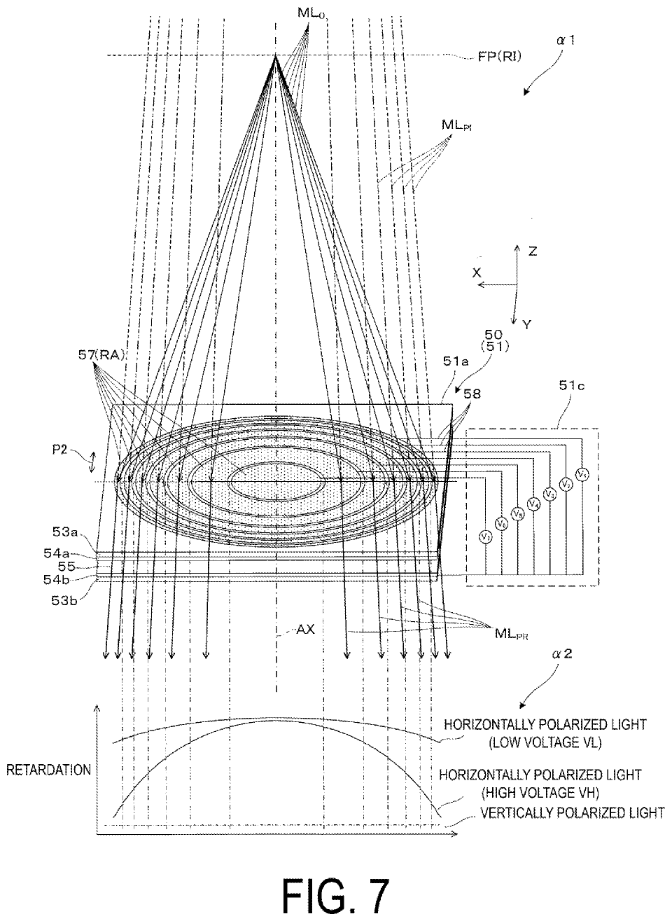

FIG. 7 is a diagram for describing a structure and a function of the polarization separation lens element 50 or the liquid crystal lens 51. In FIG. 10, an upper side α1 is a conceptual perspective view of the liquid crystal lens 51, and a lower side α2 is a chart illustrating a distribution state of retardation of the liquid crystal lens 51. The liquid crystal lens 51 is an optical element serving as a lens with respect to a specific polarization component. The liquid crystal lens 51 has refractive power that selectively acts on polarized light of the image light ML, and the refractive power is set for each of the orbicular zones RA. When vertically polarized light and horizontally polarized light are incident, the liquid crystal lens 51 selectively acts as a lens on polarized light (the second polarized light P2) in one direction according to distribution of a refractive index, and transmits polarized light (the first polarized light P1) in another direction substantially as is without acting thereon. Here, specifically, the polarized light in the one direction corresponds to the image light ML being the vertically polarized light having a polarization plane along the vertical direction, and the polarized light in the other direction specifically corresponds to the external light OL being the horizontally polarized light having a polarization plane along the horizontal direction. The liquid crystal lens 51 can be used with a fixed focus, but may also be used with a variable focus. When the distribution of the refractive index on the liquid crystal lens 51 is increased or reduced overall, the refractive power of the liquid crystal lens 51 can be increased or reduced, and the liquid crystal lens 51 can be used with a variable focus.

The liquid crystal lens 51 as the polarization separation lens element 50 includes a lens member 51a and a driving circuit 51c. The lens member 51a includes two light-transmitting substrates 53a and 53b facing each other, two electrode layers 54a and 54b provided on inner surface sides of the light-transmitting substrates 53a and 53b, and a liquid crystal layer 55 interposed between the electrode layers 54a and 54b. Note that although not illustrated in the drawing, alignment films are arranged between the electrode layers 54a and 54b and the liquid crystal layer 55 to adjust an initial alignment state of the liquid crystal layer 55. The first electrode layer 54a includes a large number of electrodes 57 arranged concentrically along the XY plane in the orbicular zone RA, and the electrodes 57 are annular transparent electrodes. The large number of electrodes 57 are spaced apart from each other, and a lateral width of the electrode 57 located on an outer side is narrowed. The lateral width of the electrode 57 affects accuracy of a refraction action of the lens member 51a. Each electrode 57 is coupled to the driving circuit 51c via a wiring line 58 insulated by an insulating layer (not illustrated), on a route in the middle. The second electrode layer 54b is a common electrode extending parallel to the XY plane, and is uniformly formed along the light-transmitting substrate 53b. Different application voltages V1 to V7 are applied to the large number of electrodes 57 to adjust a distribution state of birefringence or retardation. When the liquid crystal lens 51 has an effect of a convex lens, the application voltage V1 is set higher than the application voltage V7, and the application voltages V2 to V6 are set to values gradually changed within a voltage range of V1 to V7.

A case in which the image light ML emitted from the light modulation element 24 is incident on the liquid crystal lens 51 via the second polarizing plate 25, that is, a case in which vertically polarized light (the second polarized light P2) having a polarization plane parallel to the Y direction is incident on the liquid crystal lens 51 is considered. With regard to the vertically polarized light, a voltage applied to the electrode 57 that is arranged at the outermost side in the peripheral portion is increased to reduce retardation, and the refractive index is relatively reduced in the region. Thus, for example, in a case of light from a far point light source, the light that passes through the liquid crystal lens 51 via the electrode 57 in the peripheral portion has a wavefront that is relatively advanced. In contrast, a voltage applied to the electrode 57 that is arranged at the innermost side being the center portion is reduced to maintain retardation close to its original state, and the refractive index is relatively increased in the region. Thus, for example, in a case of light from a far point light source, the light that passes through the liquid crystal lens 51 via the electrode 57 in the center portion has a wavefront that is relatively delayed. Thus, image light ML₀ in a diverging state which is incident on the liquid crystal lens 51 from an image RI set on a predetermined focal plane FP is vertically polarized light, and passes through the liquid crystal lens 51 to be subjected to an action as a convex lens and become image light ML_{PR} in a state in which a diverging angle is reduced. Virtual image light ML _{PI} that traces back the image light ML_{PR} is from a virtual image position farther than the focal plane FP. A focal length of the liquid crystal lens 51 is a distance from a point light source to the liquid crystal lens 51 when light from the point light source is collimated. In the embodiment, the focal length is substantially equal to a distance from the light modulation element 24 to the liquid crystal lens 51. Approximately, with reference to the lens formula, the relationship expressed by 1/F=1/A+1/B is satisfied, where a distance from the focal plane FP to the liquid crystal lens 51 is A, a distance from the liquid crystal lens 51 to an image plane is B, and the focal length of the liquid crystal lens 51 is F.

Here, the distance B from the focal plane FP to the virtual image position is set to a distance as several times to several tens of times as long as the distance A from the liquid crystal lens 51 to the focal plane FP. Although detail description is omitted, the distance ratio corresponds to a magnification ratio of a virtual image. In the above, when a relative ratio of the application voltages V1 to V7 is substantially maintained so that the application voltages are set to be low, a difference in retardation between the center and the periphery decreases, and an absolute value of positive power of the liquid crystal lens 51 decreases. That is, the absolute value of the power can be increased by applying a high voltage VH to the liquid crystal lens 51, the absolute value of the power can be decreased by applying a low voltage VL to the liquid crystal lens 51, and the driving circuit 51c can cause the liquid crystal lens 51 to function as an externally adjustable varifocal lens.

The liquid crystal lens 51 functions as a varifocal lens to change the focal length F. Thus, the distance B from the liquid crystal lens 51 to the image plane position or the virtual image position can freely be changed, and adjustment of a magnification ratio can be performed. Further, even when visual acuity of the wearer US is imbalanced due to nearsightedness or the like, focus adjustment for observing a virtual image while maintaining a focused state can be performed. In other words, the image plane position or the virtual image position can be adjusted finely according to visual acuity of an individual (farsightedness, nearsightedness, astigmatism, or the like). The wearer US can perform adjustment of a magnification ratio or focus adjustment by operating the user terminal 90, for example. In other words, the virtual image display devices 100A and 100B enable customization relating to a magnification ratio and focus by an operation by the wearer US.

The liquid crystal lens 51 has an image formation action with respect to the image light ML being the vertically polarized light, and has an image formation action with respect to the image light ML being the horizontally polarized light by adjusting a rotation angle. The liquid crystal lens 51 maybe regarded as a liquid crystal lens serving as a lens with respect to a specific polarization component, and may also be regarded as a liquid crystal lens having a lens function of acting on a specific polarization component. When the liquid crystal lens 51 is arranged in front of the eyes, an eye box having a size close to that of the liquid crystal lens 51 can be secured. The eye box can be increased in size, and chipping of an image is less likely to occur. Moreover, the display optical systems 103a and 103b that are reduced in size and have a large FOV can be achieved at the same time. Moreover, by combining the composite display member 20 including the light-guiding member 22, the light modulation element 24, and the like, with the liquid crystal lens 51, display on a large screen can be performed with a small-sized optical system. Here, display on a large screen indicates a case in which a virtual image of 70 inches or larger is formed at a distance of 2.5 m ahead, for example.

The liquid crystal lens 51 is not limited to one in which retardation is gradually reduced from the center to the periphery, but may also be a Fresnel lens as disclosed, for example, in WO 2009/072670. The liquid crystal lens 51 may change an alignment direction of liquid crystal by ultrasonic waves.

Note that the external light OL that passes through the light-blocking member 21 and the like is the horizontally polarized light (first polarized light P1), and even when the external light OL passes through the liquid crystal lens 51, retardation is kept uniform in the XY plane regardless of the values of the application voltages V1 to V7. Thus, a phase difference is not imparted, and the external light OL is not affected by a lens action of the liquid crystal lens 51. In other words, the external light OL linearly advances without being substantially affected by the composite display member 20 and the polarization separation lens element 50.

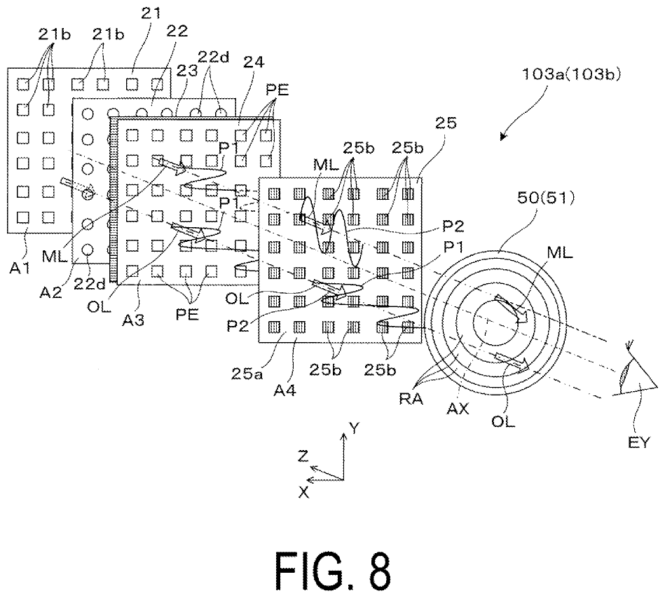

With reference to FIG. 8, the backlight BL emitted from the light extraction unit 22d of the light-guiding member 22 illuminates the liquid crystal pixel PE of the light modulation element 24 via the first polarizing plate 23. The image light ML emitted from the liquid crystal pixel PE of the light modulation element 24 is obtained by rotating a polarization plane of the backlight BL in accordance with a drive signal, and only the second polarized light P2 which is the vertically polarized light is emitted through the second polarizing plate 25. The image light ML that passes through the second polarizing plate 25 forms a virtual image via the liquid crystal lens 51 of the polarization separation lens element 50 functioning as a convex lens with respect to the second polarized light P2 being the vertically polarized light. A virtual image formed by the image light ML modulated by the light modulation element 24 and the second polarizing plate 25 is observed by the eye EY of the wearer. On the other hand, the external light OL passes through the light-transmitting region A1 of the light-blocking member 21 and passes through the parallel flat plate-shaped light-transmitting region A2 of the light-guiding member 22. Thereafter, the external light OL passes through the first polarizing plate 23, whereby the polarization direction of the external light OL is restricted to the horizontal direction. Then, the external light OL passes through the light-transmitting region A3 of the light modulation element 24, passes through the light-transmitting region A4 of the second polarizing plate 25, and finally enters the liquid crystal lens 51. At this time, the external light OL is not subjected to lens actions by the light-blocking member 21, the light-guiding member 22, the first polarizing plate 23, the light modulation element 24 and the second polarizing plate 25, and is not also subjected to a lens action by the liquid crystal lens 51. A general external image is observed by the eyes EY of the wearer. In other words, an external image can be recognized in a see-through view via the display optical systems 103a and 103b.

With reference to FIG. 3, a portion corresponding to the repetition unit 20a of the light modulation element 24 may be regarded as a combination of an external light visual recognition pixel X1 being the light-transmitting region A3 and an image light emission pixel X2 being the liquid crystal pixel PE, and is also referred to as a see-through image display pixel TX. The see-through image display pixel TX may be regarded as a pixel that allows a background scene to be viewed in a see-through manner, from the viewpoint that the see-through image display pixel TX forms a pixel at a position where the external light OL is locally blocked. The polarization direction of the external light OL that is not blocked by the light-blocking member 21 is restricted by the first polarizing plate 23. The external light OL passes through the light-transmitting region A3 being a part of the see-through image display pixel TX of the light modulation element 24, and passes through the liquid crystal lens 51 with a light beam state maintained. Meanwhile, the polarization direction of the image light ML that is emitted from the pixel section 22t being a part of the see-through image display pixel TX is restricted by the second polarizing plate 25, the image light ML passes through the liquid crystal lens 51 while being subjected to a light condensing action or a lens action, and is converted into a virtual image corresponding to display by the pixel section 22t.

Each of the virtual image display device 100A and 100B of the first embodiment described above includes: the light modulation element 24 including the liquid crystal pixel PE and the light-transmitting region A2 that transmits light, the light-blocking member 21 arranged at the external side of the light modulation element 24 and configured to suppress incidence of the external light OL on the liquid crystal pixel PE, the light-guiding member 22 arranged between the light-blocking member 21 and the light modulation element 24 and configured to emit, at a position corresponding to that of the liquid crystal pixel PE, illumination light toward the liquid crystal pixel PE, the first polarizing plate 23 arranged between the light-guiding member 22 and the light modulation element 24 and configured to restrict light incident on the liquid crystal pixel PE and the light-transmitting region A2 to polarized light in the first polarization direction (specifically, the first polarized light P1 being the horizontally polarized light, for example), the second polarizing plate 25 arranged at the face side of the light modulation element 24 and including the polarizing film 25b as the polarizing region 25p provided corresponding to the liquid crystal pixel PE, the polarizing film 25b being configured to restrict the image light ML emitted from the liquid crystal pixel PE to polarized light in the second polarization direction different from the first polarization direction (specifically, the second polarized light P2 being the vertically polarized light, for example), and the polarization separation lens element 50 arranged at the face side of the second polarizing plate 25 and having refractive power that functions with respect to polarized light (specifically, the second polarized light P2 being the vertically polarized light, for example) of the image light ML.

In each of the virtual image display devices 100A and 100B described above, the transmitted light that passes through the light-blocking member 21 from the outside world, that is, the external light OL is restricted to the first polarization direction via the first polarizing plate 23, and passes through the polarization separation lens element 50 without being subjected to an action of refractive power. The image light ML that is emitted from the liquid crystal pixel PE is restricted to the second polarization direction via the second polarizing plate 25, passes through the polarization separation lens element 50 while being subjected to an action of refractive power, and forms a virtual image. In this case, a virtual image corresponding to an image formed in the liquid crystal pixel PE of the light modulation element 24 can be formed while the light modulation element 24 and the polarization separation lens element 50 are arranged near the eye, and an angle of view can be increased without separating the light modulation element 24 and the polarization separation lens element 50 to a large degree.

### Second Embodiment

virtual image display device according to a second embodiment will be described below. Note that the virtual image display device according to the second embodiment is obtained by partially modifying the virtual image display device according to the first embodiment, and description of parts in common with those of the virtual image display device according to the first embodiment is omitted.

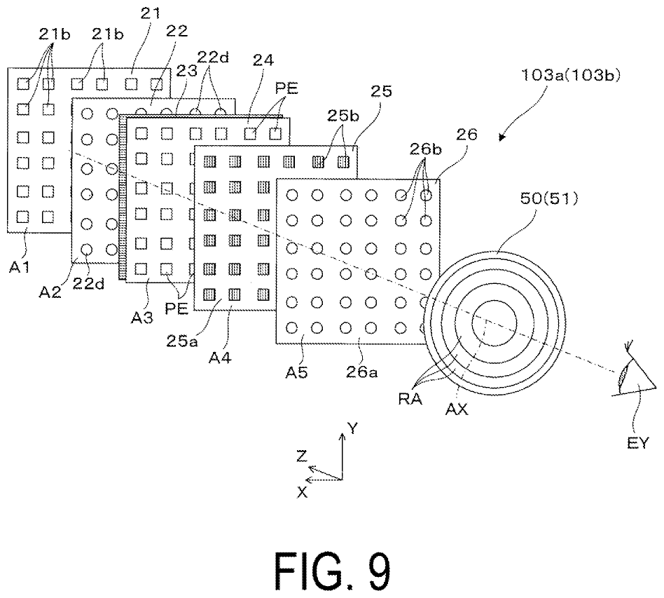

As illustrated in FIG. 9, in each of the display optical systems 103a and 103b of the embodiment, an optical array 26 is arranged between the composite display member 20 and the polarization separation lens element 50 and in the vicinity of the second polarizing plate 25. The optical array 26 is a lens array obtained by providing circular or rectangular micro optical elements 26b at a flat plate 26a that transmits light in plan view. The micro optical element 26b individually adjusts a divergence state of the image light ML from the liquid crystal pixel PE constituting the light modulation element 24. The micro optical element 26b is, for example, a microlens.

Although omitted in illustration, at the entire optical array (lens array) 26, a large number of the micro optical elements 26b are arrayed in a matrix along the XY plane. In other words, all the micro optical elements 26b constituting the optical array 26 are two-dimensionally arrayed periodically with respect to the horizontal X direction and the vertical Y direction. Each of the micro optical elements 26b is formed in a region corresponding to the liquid crystal pixel PE in each of the repetition units 20a. A flat plate portion of the optical array 26 other than a region where the micro optical element 26b is provided is used as a light-transmitting region A5 for external light.

The micro optical element 26b is arranged in the vicinity of the light modulation element 24, and hence the virtual image display device 100A can be easily reduced in thickness. In addition, by providing the microlens, a diffusion angle is further increased, and it is possible to increase an eye ring diameter when light is incident on the eye EY.

### Modification Examples and Others

Although the present disclosure has been described with reference to the above-described embodiments, the present disclosure is not limited to the above-described embodiments and can be implemented in various modes without departing from the spirit of the disclosure. For example, the following modifications are possible.

In the embodiment described above, the liquid crystal lens 51 is not limited to one including the electrode as an element, and may be one having refractive power by filling a space between a Fresnel lens-like first substrate and a flat plate-like second substrate with liquid crystal and aligning the alignment of the liquid crystal with a Fresnel lens surface.

The liquid crystal lens 51 may include an elongated circular electrode that is slightly elongated in a specific direction, instead of a circular electrode.

The liquid crystal lens 51 as the polarization separation lens element 50 is not limited to a lens including the orbicular zone RA having a ring shape. As the polarization separation lens element 50, various structures having a lens action with respect to specific polarized light may be adopted.

Although it has been assumed above that the HMD 200 is worn on the head and is used, the virtual image display devices 100A and 100B may also be used as a hand-held display that is not worn on the head and is to be looked into like binoculars.

In other words, according to an aspect of the present disclosure, the head-mounted display also includes a hand-held display.

In the embodiment described above, the arrangement and size of the liquid crystal pixel PE can be changed as appropriate so that a sufficient see-through region exists in one pixel.

A virtual image display device in a specific aspect includes: a light modulation element including a liquid crystal pixel and a light-transmitting region that transmits light, a light-blocking member arranged at the external side of the light modulation element and configured to suppress incidence of external light on the liquid crystal pixel, a light-guiding member arranged between the light-blocking member and the light modulation element and configured to emit, at a position corresponding to that of the liquid crystal pixel, illumination light toward the liquid crystal pixel, a first polarizing plate arranged between the light-guiding member and the light modulation element and configured to restrict light incident on the liquid crystal pixel and the light-transmitting region to polarized light in a first polarization direction, a second polarizing plate arranged at the face side of the light modulation element and including a polarizing region provided corresponding to the liquid crystal pixel, the polarizing region being configured to restrict image light emitted from the liquid crystal pixel to polarized light in a second polarization direction different from the first polarization direction, and a polarization separation lens element arranged at the face side of the second polarizing plate and having refractive power that functions with respect to polarized light of the image light.

In the virtual image display device described above, transmitted light that passes through the light-blocking member from an outside world, that is, the external light is restricted to the first polarization direction via the first polarizing plate, and passes through the polarization separation lens element without being subjected to an action of refractive power. The image light that is emitted from the liquid crystal pixel is restricted to the second polarization direction via the second polarizing plate, passes through the polarization separation lens element while being subjected to an action of refractive power, and forms a virtual image. In this case, a virtual image corresponding to an image formed in the liquid crystal pixel of the light modulation element can be formed while the light modulation element and the polarization separation lens element are arranged near an eye, and an angle of view can be increased without separating the light modulation element and the polarization separation lens element to a large degree.

In a virtual image display device in a specific aspect, the polarizing regions of the second polarizing plate are discretely provided corresponding to the liquid crystal pixels.

A virtual image display device in a specific aspect further includes a light source device configured to supply light of three colors to the light-guiding member in a time-division manner. Thus, the liquid crystal pixel can be irradiated with the light of three colors in a time-division manner, and it is permissible for a density of the liquid crystal pixels constituting the light modulation element to be low even when color display is performed. This makes it possible to increase a proportion of the light-transmitting region in the light modulation element and improve a see-through transmittance.

In a virtual image display device in a specific aspect, the light-guiding member is a parallel flat plate-shaped member, and includes light extraction units discretely provided corresponding to the liquid crystal pixels and configured to emit light of three colors to the liquid crystal pixels. The light extraction unit can efficiently extract the illumination light at a necessary position, by disturbing propagation of the illumination light using total reflection or the like by the parallel flat plate-shaped member.

In a virtual image display device in a specific aspect, the light extraction unit is any one of a light scattering layer, a nanostructure, and a microlens.

In a virtual image display device in a specific aspect, the light-blocking member includes a light-blocking layer that suppresses incidence of the external light, and the light-blocking layer has a size corresponding to that of the light extraction unit. In this manner, incidence of the external light on the scattering region can be further suppressed.

In a virtual image display device in a specific aspect, the polarization separation lens element is a polarization separation liquid crystal lens that causes a plurality of liquid crystal pixels to collectively form an image. With an independent lens, an eye box can be enlarged.

In a virtual image display device in a specific aspect, the light-blocking member, the light-guiding member, the first polarizing plate, the light modulation element, and the second polarizing plate are integrated as a plate-like member and form a composite display member; in the composite display member, the light-guiding member is a parallel flat plate-shaped member arranged away from the light-blocking member and the first polarizing plate and including a pair of flat surfaces; and the polarization separation lens element is arranged away from the composite display member. Accordingly, it is possible to reduce the device in thickness and weight, while securing propagation of the illumination light in the light-guiding member.

A virtual image display device in a specific aspect further includes a lens array arranged between the second polarizing plate and the polarization separation lens element and in the vicinity of the second polarizing plate and including microlenses discretely provided corresponding to the liquid crystal pixels, the microlenses being configured to adjust divergence angles of the image light emitted from the liquid crystal pixels, respectively. A region where the image light is incident on the polarization separation lens element can be widened by the microlens, and a wide eye box can be secured.

According to a specific aspect, a head-mounted display apparatus includes a first device including the virtual image display device described above, a second device including the virtual image display device described above, and a support device including a temple supporting the first device and the second device, the temple being configured to enable mounting of the first device and the second device on a head.

What is claimed is:

1. A virtual image display device comprising:
a light modulation element including a liquid crystal pixel and a light-transmitting region configured to transmit light;
a light-blocking member arranged at an external side of the light modulation element and configured to suppress incidence of external light on the liquid crystal pixel;
a light-guiding member arranged between the light-blocking member and the light modulation element and configured to emit, at a position corresponding to that of the liquid crystal pixel, illumination light toward the liquid crystal pixel;
a first polarizing plate arranged between the light-guiding member and the light modulation element and configured to restrict light incident on the liquid crystal pixel and the light-transmitting region to polarized light in a first polarization direction;
a second polarizing plate arranged at a face side of the light modulation element and including a polarizing region provided corresponding to the liquid crystal pixel, the polarizing region being configured to restrict image light emitted from the liquid crystal pixel to polarized light in a second polarization direction different from the first polarization direction; and
a polarization separation lens element arranged at a face side of the second polarizing plate and having refractive power configured to function with respect to polarized light of the image light.

2. The virtual image display device according to claim 1, wherein
the polarizing regions of the second polarizing plate are discretely provided corresponding to the liquid crystal pixels.

3. The virtual image display device according to claim 1, further comprising
a light source device configured to supply light of three colors to the light-guiding member in a time-division manner.

4. The virtual image display device according to claim 1, wherein
the light-guiding member is a parallel flat plate-shaped member, and includes light extraction units discretely provided corresponding to the liquid crystal pixels and configured to emit light of three colors to the liquid crystal pixels.

5. The virtual image display device according to claim 3, wherein
the light extraction unit is any one of a light scattering layer, a nanostructure, and a microlens.

6. The virtual image display device according to claim 5, wherein
the light-blocking member includes a light-blocking layer configured to suppress incidence of the external light and
the light-blocking layer has a size corresponding to that of the light extraction unit.

7. The virtual image display device according to claim 1, wherein
the polarization separation lens element is a polarization separation liquid crystal lens configured to cause a plurality of the liquid crystal pixels to collectively form an image.

8. The virtual image display device according to claim 7, wherein
the light-blocking member, the light-guiding member, the first polarizing plate, the light modulation element, and the second polarizing plate are integrated as a plate-like member and form a composite display member,
in the composite display member, the light-guiding member is a parallel flat plate-shaped member arranged away from the light-blocking member and the first polarizing plate and including a pair of flat surfaces, and
the polarization separation lens element is arranged away from the composite display member.

9. The virtual image display device according to claim 8, further comprising
a lens array arranged between the second polarizing plate and the polarization separation lens element and in a vicinity of the second polarizing plate and including microlenses discretely provided corresponding to the liquid crystal pixels, the microlenses being configured to adjust divergence angles of the image light emitted from the liquid crystal pixels, respectively.

10. A head-mounted display apparatus comprising:
a first device including the virtual image display device according to claim 1;
a second device including the virtual image display device according to claim 1; and
a support device including a temple supporting the first device and the second device, the temple being configured to enable mounting of the first device and the second device on a head.
